(19) United States
(12) Patent Application Publication
(10) Pub. No.: US 2003/0079461 A1
(43) Pub. Date: May 1, 2003

(54) Gas turbine and combustor therefor

(75) Inventors: Shigemi Mandai, Takasago-shi (JP); Masataka Ohta, Takasago-shi (JP); Katsunori Tanaka, Takasago-shi (JP); Koichi Nishida, Takasago-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI HEAVY INDUSTRIES, LTD., Tokyo (JP)

(21) Appl. No.: 10/279,847

(22) Filed: Oct. 25, 2002

(30) Foreign Application Priority Data
Oct. 29, 2001 (JP) 2001-331134
Aug. 9, 2002 (JP) 2002-234192

(51) Int. Cl. F02C 3/30

(52) U.S. Cl. 60/39.55; 60/752

(57) ABSTRACT

A combustor section is disposed downstream of a nozzle section. The combustor section extends from a downstream end of the nozzle section to an entrance of a gas turbine and supplies a combustion gas which is generated by combusting a pre-mixed gas to a gas turbine. The combustor section is formed by an inner tube and a tail tube unitarily. The combustor is provided with a wall cooling apparatus for cooling a wall surface of the combustor. On the inner wall of the combustor section, grooves are formed. An entrance for introducing an air for cooling action is disposed on the outer wall of the combustor section. The introduced air performs a film cooling and convective cooling in a combined manner. By doing this, the temperature of the combustion gas may be high, and a highly efficient gas turbine is realized.

### BACKGROUND OF THE INVENTION

1. Field of the Invention

The present invention relates to a combustor which advantageously combusts fuels having low heat generating content. The present invention also relates to a gas turbine having the above-mentioned combustor.

2. Description of Related Art

FIG. 8 shows a conventional combustor. The combustor 1 is equipped to a gas turbine which combusts a low calorie fuel. In the combustor 1, when a fuel is injected to a nozzle section 2 by a main nozzle 3, a combustion gas is generated by a combustion of the fuel which is ignited by a combustor section 4. The combustion gas is supplied to a gas turbine (not show in the drawing) which is located downstream thereof. The combustor section 4 comprises an inner tube 5 which is connected to the nozzle section 2 and a tail tube 6 which is connected to the inner tube.

In such a combustor 1, it is necessary to cool a wall of the combustor section 4. For such a cooling action, a compressed air which is compressed by an air compressor is used. That is, a wall of the combustor section 4 comprises an outer wall 7a and an inner 7b as shown in FIG. 9. An air intake port 7c is formed on the outer wall 7a, and numerous grooves 7d are formed on the inner wall 7b. The air from the air compressor is introduced from the air intake port 7c formed on the outer wall 7a. The air flows along the grooves 7d formed on the inner wall 7b. By doing this, the inner wall 7b is cooled by a convective cooling action. The air used for such convective cooling action flows along an inner surface of the inner wall 7b and performs a film cooling action on the inner wall 7b. Accordingly, the wall of the combustor is cooled by the film cooling action and the convective cooling action in a combined manner.

The amount of heat which is generated by a fuel such as a blast furnace gas having 700 kcal or a coal gas which is supplied to the combustor 1 lower than the amount of heat generated by an ordinary gas turbine fuel such as by natural gas. In such a gas turbine combustor for combusting such a low calorie fuel, it is necessary to increase the amount of fuel in order to attain high temperatures at an entrance of the turbine. When the amount of the fuel increased, the air which is supplied for combustion must be increased corresponding to the increase in the amount of the fuel. Therefore, air which is used for the cooling action is relatively decreased. This means a lack of air (hereinafter called wall cooling air) which can be used for cooling the wall of the combustor 1.

At present, gas turbines in which sufficient wall cooling air cannot be obtained only having low entrance temperatures such as nearly 1100° C. have been realized.

In such a conventional gas turbine, a high temperature at the entrance of the turbine is desired from an efficiency point of view. Therefore, it is required that a combustor for supplying the combustion gas be operated under higher temperature condition.

On the other hand, the combustor for supplying high temperature combustion gas to the gas turbine is exposed to high temperatures. For the purpose of safe operation of the combustor, greater cooling capacity becomes necessary in the combustor. However, in the conventional combustor 1 and the gas turbine using the conventional combustor 1, there was an insufficient sufficient amount of air which is necessary for cooling the wall of the combustor 1 because a lot of air is used for combustion. Therefore, there is a problem in that it is difficult to realize a combustor having a balance between sufficient combustion capacity and cooling capacity. Such a problem becomes evident in a combustor which is used in a gas turbine for combusting a low calorie fuel.

The present invention was made in consideration of the above-mentioned problem. An object of the present invention is to realize a combustion of gas at higher temperatures so as to operate a gas turbine efficiently.

### SUMMARY OF THE INVENTION

In order to achieve the above-mentioned object, the present invention provides the following features.

In a first aspect of the present invention, a combustor comprises an inner tube for generating a combustion gas, and a tail tube for introducing the combustion gas to a turbine. In this aspect of the present invention, the inner tube and the tail tube are formed unitarily.

In such a combustor according to the present invention, as far as an entire structure from a nozzle section to an entrance of the gas turbine is concerned, an inner tube and a tail tube are formed unitarily. By doing this, surface areas of an inner tube and a tail gate which must be cooled become less than surface areas in the conventional gas turbine. Therefore, it is possible to perform more efficient cooling action with less air for the cooling action. Also, the cooling action requires less air; and therefore, more air can be used for combustion. As a result, it is possible to realize a combustion of gas at higher temperatures by reacting with more fuel.

In a second aspect of the present invention, a combustor further comprises a wall cooling apparatus for cooling the wall of the combustor having the inner tube and the tail tube.

In such a combustor according to the present invention, efficient cooling action is possible by performing a wall cooling action; thus, the amount of air for combustion is increased. Therefore, more air reacts with more fuel; and combustion at higher temperatures becomes possible.

In a third aspect of a combustor according to the present invention, the wall cooling apparatus performs a film cooling action and a convective cooling operation in a combined manner.

In, such a combustor, it is possible to perform a dual cooling action by a film cooling action and a convective cooling action. By doing this, it is possible to perform cooling action efficiently with less air. Therefore, more air reacts with more fuels; and combustion at higher temperatures becomes possible because air for combustion use increases.

In a fourth aspect of a combustor according to the present invention, the wall cooling apparatus performs cooling action using air and steam compatibly.

In such a combustor according to the present invention, by using steam for cooling the wall, the amount of air for cooling the wall may be decreased. Air which can be used for combustion is increased; and, more air reacts with more fuel and therefore, combustion at higher temperatures becomes possible.

In a fifth aspect of a combustor according to the present invention, the wall cooling apparatus performs cooling action using steam.

In such a combustor according to the present invention, by using only steam for cooling the wall, the amount of air for cooling the wall is decreased. Air which can be used for combustion increases, and thus, more air can react with more fuel and therefore, combustion at higher temperatures becomes possible.

In a sixth aspect of a combustor according to the present invention, low calorie fuel is used in the combustor.

In such a combustor according to the present invention, air used for cooling is decreased. Otherwise, air for cooling is not necessary. Therefore, air which can be used for combustion is increased. More air reacts with more fuels, and therefore, combustion at higher temperatures becomes possible even while inexpensive low calorie fuels is used.

In a seventh aspect of the present invention, a gas turbine comprises an air compressor for compressing air, a combustor according to any one of the above-mentioned aspects, and a turbine which produces shaft horse power by rotating a shaft thereof by expanding the combustion gas introduced from the combustor.

In such a gas turbine, the amount of cooling air in the combustor is decreased. Otherwise, air for cooling is not necessary. Therefore, air which can be used for combustion is increased. More air reacts with more fuel, and therefore, combustion at higher temperatures becomes possible. As a result, more efficient operation of gas turbines can be realized.

As explained above, according to the first aspect of the present invention, it is possible to perform more efficient cooling action with less air. Also, the cooling action requires less air, and therefore, more air can be used for combustion. As a result, it is possible to realize combustion of gas at higher temperatures by reacting with more fuel.

According to the second aspect of the present invention, efficient cooling action is possible by performing a wall cooling action, and thus, the amount of air for combustion is increased. Therefore, more air reacts with more fuels, and therefore, combustion at higher temperatures becomes possible.

According to the third aspect of the present invention, it is possible to perform a dual cooling action by a film cooling action and a convective cooling action. By doing this, it is possible to perform cooling action efficiently with less air. Therefore, more air is reacted with more fuel, and thus, combustion at higher temperatures becomes possible because air for combustion is increased.

According to the fourth aspect of the present invention, by using steam for cooling the wall, the amount of air for cooling the wall is decreased. Air which can be used for combustion is increased, and thus, more air reacts with more fuels, and therefore, combustion at higher temperatures becomes possible.

According to the fifth aspect of the present invention, by using only steam for cooling the wall, the amount of air for cooling the wall is decreased. Air which can be used for combustion is increased, and thus, more air is reacted with more fuel, and therefore, combustion at higher temperatures becomes possible.

According to the sixth aspect of the present invention, air used for cooling is decreased. Otherwise, air for cooling is not necessary. Therefore, air which can be used for combustion is increased. More air is reacted with more fuel, and therefore, combustion at higher temperatures becomes possible even when inexpensive low calorie fuel is used.

According to the seventh aspect of the present invention, the amount of cooling air in the combustor is decreased. Otherwise, air for cooling is not necessary. Therefore, air which can be used for combustion is increased. More air reacts with more fuel, and therefore, combustion at higher temperatures becomes possible. As a result, more efficient operation of gas turbines can be realized.

### BRIEF DESCRIPTION OF THE DRAWINGS

FIG. 1 is a cross section of a combustor according to the first embodiment of the present invention.

FIG. 2 is a view showing an inner structure of a wall cooling apparatus in a combustor section of a combustor shown in FIG. 1.

FIG. 3 is a cross section of a combustor according to the second embodiment of the present invention.

FIG. 4 is a view showing an inner structure of a wall cooling apparatus in a combustor section of a combustor shown in FIG. 3.

FIG. 5 is a cross section of a combustor according to the third embodiment of the present invention.

FIG. 6 is a view showing an inner structure of a wall cooling apparatus in a combustor section of a combustor shown in FIG. 5.

FIG. 7 is a cross section of an embodiment of a gas turbine according to the present invention.

FIG. 8 is a view showing a conventional combustor.

FIG. 9 is a view showing an inner structure of a wall cooing apparatus in a conventional combustor.

### DETAILED DESCRIPTION OF THE INVENTION

Embodiments of the present invention are explained with reference to the drawings as follows.

First Embodiment

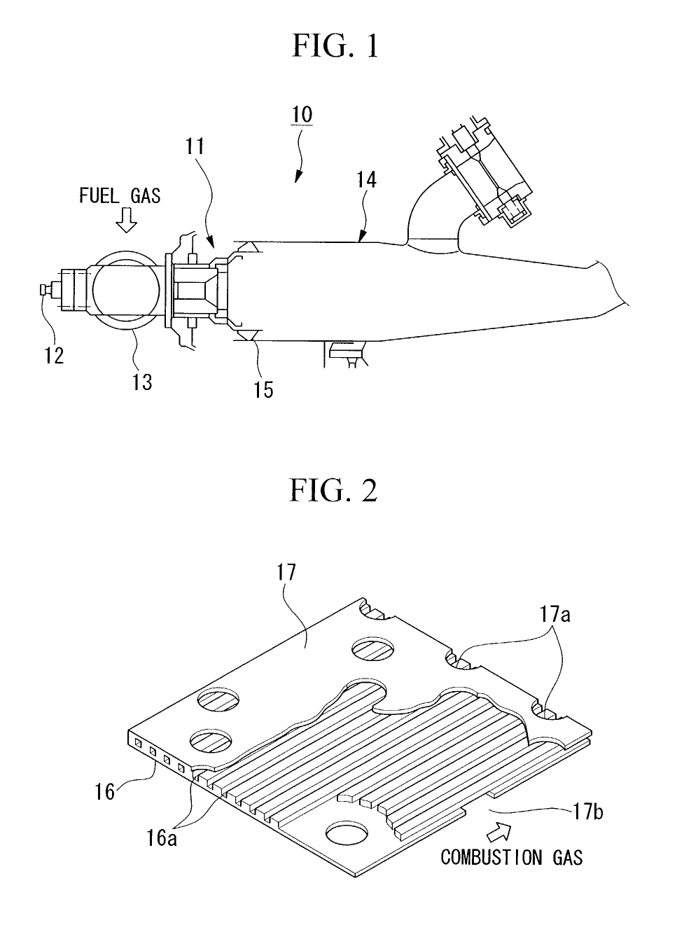

FIGS. 1 and 2 show one aspect of the combustor according to the present invention. More precisely, FIG. 1 is a cross section of the combustor. FIG. 2 shows important portions for cooling action of the combustor. A combustor shown in FIG. 1 combusts a fuel for generating a combustion gas which drives a turbine (not shown in the drawing). The combustor 10 is provided with a nozzle section 11.

In the nozzle section 11, a pilot nozzle 12 and a main nozzle 13 are contained. An air which is compressed by an air compressor (not shown in the drawing) is supplied in the nozzle section 11 so as to be mixed with a fuel supplied from the pilot nozzle 12. A mixture of the air and the fuel is ignited thereat; thus, a pilot flame is formed there.

The main nozzle 13 injects the fuel. The fuel is ignited by the pilot flame. The ignited fuel reacts with the air which is compressed by the air compressor. Thus, a diffusion combustion occurs and the combustion gas is generated.

In a downstream portion of the nozzle section 11, a combustor section 14 having a one-piece structure in which an inner tube and a tail tube are formed unitarily is formed. A wall of the combustor section 14 has a dual wall structure formed by an inner wall 16 and an outer wall 17 as shown in FIG. 2. The combustor section 14 and the nozzle section 11 form a combustor. The combustor section 14 extends from the end of the downstream of the nozzle section 11 to an entrance of the turbine which is not shown in the drawing. The combustor section 14 sends the combustion gas which is generated in the combustion therein to the turbine. More specifically, an upstream end of the combustor section 14 is connected to a downstream end of the nozzle section 11 via an spring coupling 15 which is disposed in the nozzle section 11 as shown in FIG. 1. The downstream end of the combustor section 14 is disposed at an entrance of the turbine.

As explained above, in the combustor 10, the nozzle section 11 and the combustor section 14 having a one-piece structure are connected. When a combustion gas is supplied to the turbine (not shown in the drawing), the turbine is rotated by the combustion gas and generates a shaft horse power.

In the combustor 10, a wall cooling apparatus for cooling the wall of the combustor 10 is provided. In the wall cooling apparatus, a convective cooling action and a film cooling action are performed such that a compressed air which is compressed by an air compressor (not shown in the drawing) is introduced from an entrance 17a of the outer wall 17 forming the combustor section 14 to the outer wall 17, and the compressed air flows along numerous grooves 16a which are formed in the inner wall 16 so as to perform the convective cooling action, and the compressed air flows along the inner face of the inner wall 16 so as to perform the film cooling action. That is, the wall cooling apparatus performs the convective cooling action and the film cooling action in a combined manner. Here, in FIG. 2, reference numeral 17b indicates an exit for a cooling agent.

In the present embodiment, the combustor 10 has the above-mentioned structure. A pilot flame is formed when the pilot fuel which is injected from the pilot nozzle 12 is further injected from the nozzle section 11 and is ignited thereat. Under such conditions, when a fuel is injected from the main nozzle 13, the mixture of the fuel and the air is combusted in the combustor section 14 so as to generate the combustion gas. At the same time, the combustion gas which is generated thereat is supplied to the entrance of the gas turbine which is disposed downstream of the combustor section 14. By doing this, a shaft horse power is obtained from the rotation of the turbine.

Here, the combustor 10 comprises the nozzle section 11 and the combustor section 14. The combustor section 14 has a one-piece structure. Therefore, the surface area of the combustor section 14 to be cooled is smaller than the surface area of the conventional combustor having the combustor section 14 not having a one-piece structure.

Therefore, the amount of air for cooling use which is supplied to the wall cooling apparatus decreases by decreasing the surface area of the combustor section 14 to be cooled. Therefore, a high temperature gas turbine having 1300° C. to 1500° C. capacity can be realized even if the amount of air which is supplied to the wall cooling apparatus is decreased or the fuel is a low calorie fuel. Thus, a high temperature gas turbine can be realized.

Also, as explained above, the combustor 10 comprises the nozzle section 11 and the combustor section 14. Therefore, the structure of the combustor 10 can be simplified; thus, the cost for manufacturing the gas turbine of the present invention can be reduced.

Furthermore, in the present embodiment, a wall cooling apparatus performs the convective cooling action and a film cooling action compatibly with the wall cooling section by using air. Thus, in the combustor according to the present invention, the cooling action is performed in a combined manner. Therefore, it is possible for both the amount of air required for cooling the wall to be reduced and the cooling efficiency to be increased. By doing this, the amount of air for cooling the wall per unit surface area of the combustor section 14 can certainly be reduced.

Here, in the combustor 10 according to the present embodiment, the surface area of the combustor section 14 can be reduced to 60 to 80% comparing the conventional combustor section. Also, the amount of air cooling the wall can be reduced to 30 to 40% comparing the conventional combustor section.

Second Embodiment

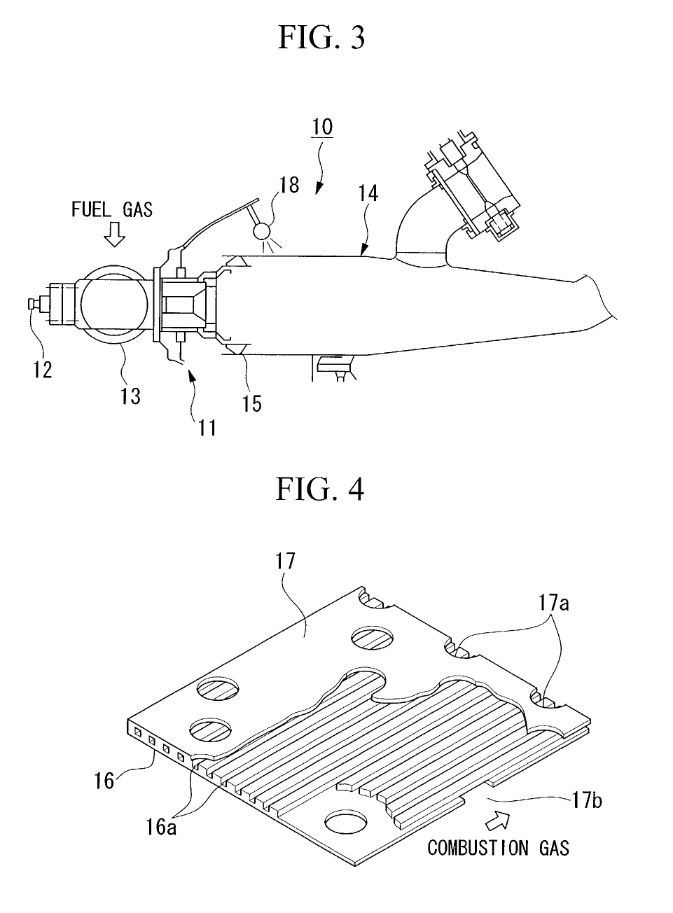

FIGS. 3 and 4 show a second embodiment of the present invention. The second embodiment of the present invention is different from the first embodiment in that the wall cooling apparatus performs a cooling action using air and steam. That is, the wall cooling apparatus has pipes for sending air which is compressed by an air compressor to an entrance 17a of an outer wall 17 in a combustor section 14. Also, as shown in FIG. 3, the wall cooling apparatus has a steam supply section 18 for supplying steam to the entrance 17a.

In the present embodiment, as for a steam which is supplied to the steam supply section 18, a portion of air which is used in a waste heat recovering boiler (not shown in the drawing) which is used in a combined plant is used. The steam is injected to the outer wall 17 together with the air which is introduced from the entrance 17a during operating the combustor 10. The steam and the air both act at the surface and the inner surface of the inner wall 16 on the combustor section 14. Thus, the surface of the wall is cooled by a combination of film cooling action by an air and a steam and a convective cooling action.

In the present embodiment, the nozzle section 11 and the combustor section 14 are connected; thus, the same effects are obtained as in the first embodiment. In addition, the wall cooling apparatus uses both an air and a steam compatibly, therefore, the air used for cooling action can be reduced by using the steam for cooling action. Accordingly, the amount of air used for cooling the wall of the combustor can be reduced.

Third Embodiment

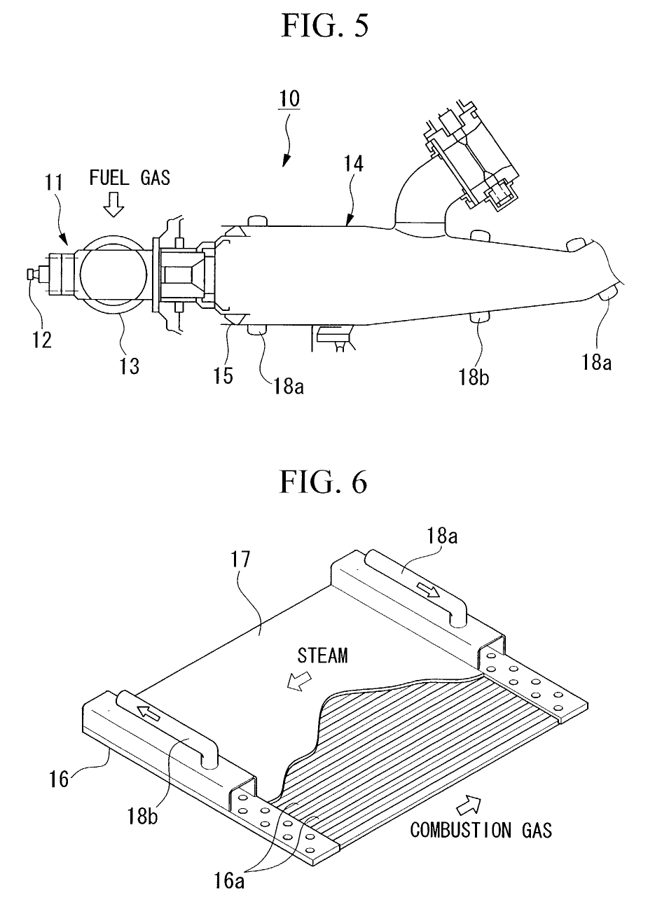

FIGS. 5 and 6 show a third embodiment of the present invention.

In the third embodiment, the wall cooling apparatus performs the cooling action only by steam. That is, in the wall cooling apparatus according to the present embodiment, as shown in FIG. 6, an entrance 18a and an exit 18b are connected to an outer wall 17 on the combustor section 14. The steam which is introduced from the entrance 18a passes through a groove 16a of an inner wall 16 on the combustor section 14 and performs the convective cooling action thereof, and is exhausted from the exit 18b. The combustor section 14 is cooled in the above-explained manner. Here, the entrances 18a are disposed at the downstream end of the outer wall of the combustor section 14 and at the upstream end of the outer wall of the combustor section 14 as shown in FIG. 5.. In addition, the exit 18b is disposed in between the entrance 18a at the upstream of the outer wall 17 and the entrance 18a at the downstream of the outer wall 17.

As explained above, when the wall surface of the combustor 10 is cooled only by a steam, the air for cooling use is not necessary. Therefore, it is possible to use all of the air which is supplied from an air compressor for combustion use. In the present embodiment, the combustor section 14 has a one-piece structure in which the inner tube and the tail tube are formed unitarily. Thus, the surface area of the overall combustor can be reduced. Also, the cooling action of the wall can be performed by a steam only. That is, the amount of the air for the use of wall surface cooling becomes zero. A combustor using a low calorie fuel and having a capacity of 1300° C. to 1500° C. can be realized.

When a gas turbine according to the present invention is used for a combustor in which a low calorie fuel is combusted, the amount of air which is used for cooling the wall may decrease. Otherwise such air is not necessary. Thus, in a wall cooling action, a surface area which must be cooled decreases, and an air for cooling action is not necessary. Therefore, cooling efficiency increases. Accordingly, such a wall cooling action is quite useful for enhancing efficiency of the gas turbine using high temperature combustion gas

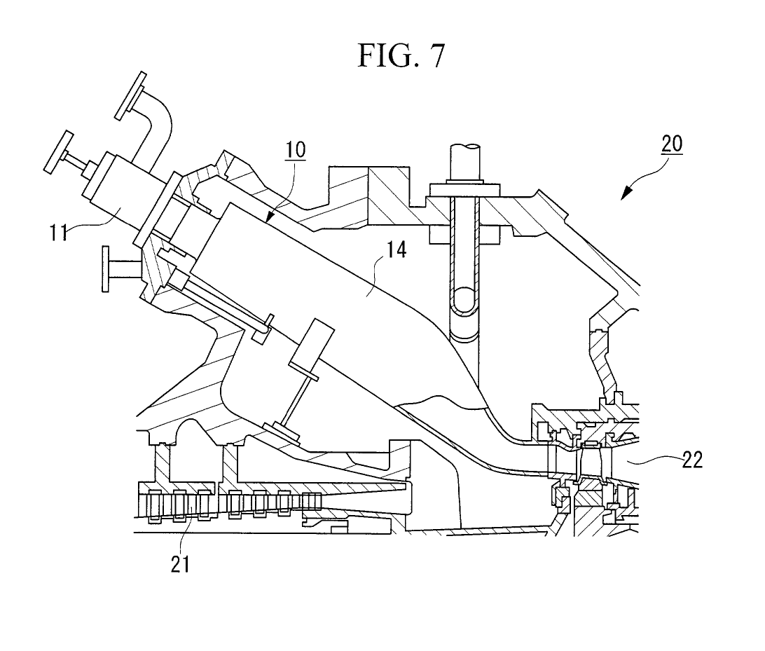

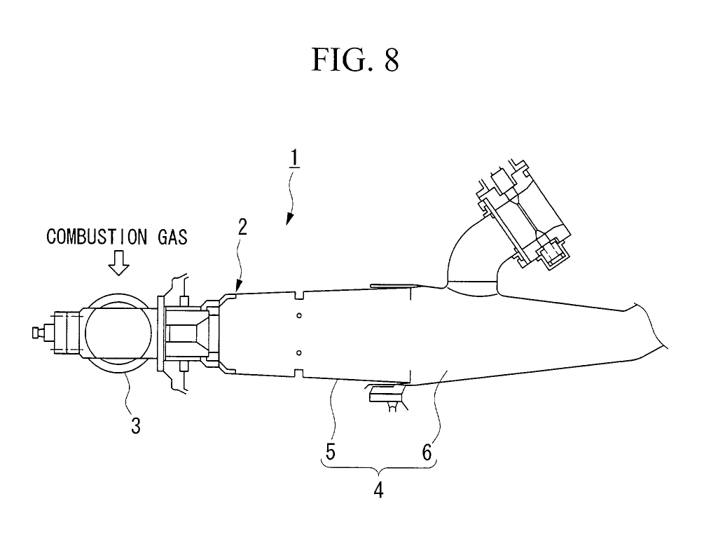

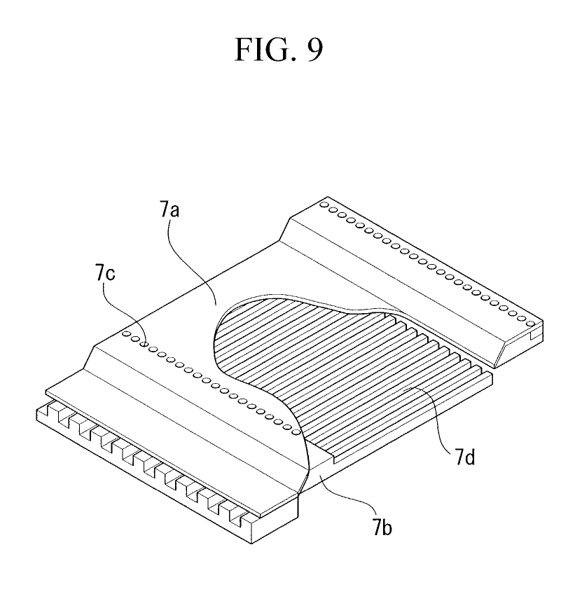

FIG. 7 shows an embodiment of a gas turbine according to the present invention. That is, a gas turbine 20 shown in FIG. 7 is provided with a combustor 10 according to the present invention.

In the gas turbine 20, an air introduced thereto is compressed by an air compressor 21. The compressed air is supplied to the combustor 10 for combustion use and also cooling use as shown in FIGS. 1 and 3. Fuel is supplied from a combustor nozzle 11 to the combustor section 14 so as to be mixed with the compressed air and is combusted thereat. A high temperature high pressure gas is generated in this way and is supplied to the gas turbine 22. The high-temperature-high-pressure gas expands and passes through stator blades which are fixed on a turbine 22 near a casing and rotor blades which are fixed near a rotor shaft. Therefore, the rotor shaft disposed near the rotor blades rotates and shaft horse power is generated.

In the above-explained embodiments according to the present invention, only the combustor which is used in the gas turbine using low calorie fuel is shown. It is certain that the present invention can also be applied to a combustor of a gas turbine using high calorie fuel.

What is claimed is:

1. A combustor comprising:
an inner tube for generating a combustion gas; and
a tail tube for introducing the combustion gas to a turbine; wherein the inner tube the tail tube are formed unitarily.

2. A combustor according to claim 1 further comprising a wall cooling apparatus for cooling the wall of the combustor having the inner tube and the tail tube.

3. A combustor according to claim 2 wherein the wall cooling apparatus performs a film cooling action and a convective cooing operation in a combined manner.

4. A combustor according to claim 2 wherein the wall cooling apparatus performs cooling action using air and steam compatibly.

5. A combustor according to claim 2 wherein the wall cooling apparatus performs cooling action using steam.

6. A combustor according to any one of claims 1 to 5 wherein low calorie fuel is used therein.

7. A gas turbine comprising:
an air compressor for compressing air;
a combustor according to any one of claims 1 to 6;
a turbine which produces shaft horse power by rotating thereof by expanding the combustion gas introduced from the combustor.
